(19) United States
(12) Patent Application Publication
(10) Pub. No.: US 2005/0105556 A1
(43) Pub. Date: May 19, 2005

(54) Packet processor and buffer memory controller for extracting and aligning packet header fields to improve efficiency of packet header processing of main processor and method and medium therefor

(75) Inventors: Jinoo Joung, Yongin-si (KR); In-cheol Park, Yuseong-gu (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/988,664

(22) Filed: Nov. 16, 2004

(30) Foreign Application Priority Data
Nov. 17, 2003 (KR) 2003-81170

(51) Int. Cl. H04J 3/22; H04J 3/16; H04L 12/56; H04L 12/28

(52) U.S. Cl. 370/469

(57) ABSTRACT

A packet processor which extracts a packet header field, word-aligns the extracted packet header field, and stores the aligned data in an external memory, for a main processor which processes packets received through a packet communication network. The packet processor includes: a serial-to-parallel converter for converting a packet in a bit stream, which is received via the packet communication network, into a word data, the word data being in a word unit(s) which includes at least one byte; a queue for temporarily storing the converted word data; and a computation part for selecting, among the word data stored in the queue, a word data that corresponds to the packet header, performing bit operations with the selected word data to extract a field therefrom, and expanding the extracted field into word alignment and providing it to the main processor. Computational requirements for the main processor to do bit operations for packet header processing are reduced, and therefore, packet processing efficiency can be improved.

### CROSS-REFERENCE TO RELATED APPLICATIONS

This application claims the priority benefit of Korean Patent Application No. 2003-81170 filed Nov. 17, 2003, in the Korean Intellectual Property Office, the disclosure of which is incorporated herein by reference.

### BACKGROUND OF THE INVENTION

1. Field of the Invention

The present invention relates to a packet processor, a buffer memory controller, and a method thereof for extracting and aligning network packet header fields, and more particularly, to a packet processor, a buffer memory controller, and a method thereof for extracting each field of received packet headers and aligning the extracted fields into a fixed unit(s) (e.g., a byte(s) or word), thereby reducing the burden of header processing bit manipulations in the main processor.

2. Description of the Related Art

In a network, data is transmitted in a predetermined format, called a “packet.” A packet usually contains a header part and a packet data part. The header part of the packet contains information for packet transmission and reception, such as addresses of the transmitter and the receiver, and protocol-related information used in packet processing, etc. The packet data part contains the actual data/information being transmitted.

The packet header part includes a plurality of fields, each having certain values indicating identifying information of the packet. In order to minimize the length of the header, the fields may vary in length.

In a general network apparatus, a processor is designed to perform computations by bytes (8 bits), or by words, which are usually formed of 4 bytes. Accordingly, a received packet is segmented into a byte or word for processing by the processor. This will now be further explained below, with reference to processing by words, but one will appreciate that it equally applicable to processing by bytes.

A received serial bit stream can be divided into a word, and converted into word-unit parallel data, which the processor can process.

Because the fields of the packet header portion have various sizes, each field is not always segmented and parallelized into in one word, but rather, a plurality of fields may be combinable for one word, or one field may be segmented into a plurality of words. Accordingly, in order to analyze the differently sized fields, certain manipulations are required to extract fields from a word, and match the extracted fields into a word having a format suitable for the corresponding processors.

In other words, if one or more fields are contained in one word, some bit-manipulations are required, through a series of instructions such as shift, masking and padding, with respect to the word to extract the fields of the word and match the fields in word size, and thus to analyze one field contained in the word.

If one field is contained in a plurality of words, the field needs to be extracted with manipulations, such as shift and masking, which separate parts corresponding to the field within a plurality of words, and then merge the separated parts into a word-unit, which makes field analysis becomes even more complex. Manipulations, such as extracting the fields from the word, and matching the extracted fields in word-units for computation at the processor will herein be called a “word alignment” process.

Generally, word alignment is performed by the processor. When the speed of the network is slow, word alignment does not affect the packet processing time considerably. However, as the network speed increases, less processing time will be available for the processing of each packet. A general processor, which is not specialized for the bit-manipulations, will not efficiently perform the word alignment and packet processing.

Conversely, a hardware unit, devoted to fast packet processing, can be used to overcome the above-mentioned drawback. However, this type of hardware requires a considerable amount of design time, and is quite inefficient when considering the frequently updated network standards, as it is difficult to modify the hardware unit once designed.

Another suggestion was to add devoted instructions to the processor, for the word alignment function. Processors, however, are generally designed to operate optimally with the process of complicated determinations and multiple instructions, and therefore, adding additional instructions, only for bit-manipulation, is not easy. Even if the instructions are added for the bit-manipulations, the overall performance of the processor system may deteriorate. Particularly under program development environments, such as a C compiler, using instructions for bit manipulations is almost impossible.

FIG. 1 illustrates a network apparatus explaining general packet processing.

A general network apparatus receives a bit stream of serial data, converts the received data into parallel data through a series-to-parallel converter (not shown), and stores the parallel data in a memory 120 in bytes, or words. Both the headers and the packet data are stored in the memory 120 in bytes, or words.

A main processor 130 reads out a part from the data of the memory 120, thereby processing packets. In order to reduce the load to the main processor 130 and to increase I/O speed of the memory 120, a direct memory access (DMA) 110 is generally used.

The DMA 110 stores the data in the memory 120 directly, that is, without an intervention of the main processor 130. When the DMA 110 completes the storing of the packet in the memory 120, the main processor 130 starts analyzing packets stored in the memory 120. For the packet analysis, the main processor 130 inspects each of the fields contained in the packet header, requiring a considerable number of bit-wise manipulations for the word alignment. In order to check the occurrence of error in the packet transmission, the entire packet has to be read for the computations, e.g., CRC (Cyclic Redundancy Check) or checksum, thereby requiring a large amount of time for the overall process.

The above operations usually deteriorate the utilization of resources and efficiency of the processor, which is designed to best fit the word-wise computations. Also, the amount of time required for packet processing is on the rise. Because processors are designed generally for complex computations, processes such as protocol processing and processes like extracting of packet header fields and alignment, which require real-time bit-wise manipulation, usually deteriorate performance of the processor.

### SUMMARY OF THE INVENTION

Embodiments of the present invention have been developed in order to solve the above drawbacks and other problems associated with the conventional arrangement. An aspect of the present invention is to at least provide a packet processor, a buffer memory controller, and methods and media thereof, capable of reducing requirements for bit-wise computations in a packet header processing in a main processor and enhancing packet processing efficiency, by extracting fields corresponding to the header of the received packet and word-wise aligning the extracted fields.

Additional aspects and/or advantages of the invention will be set forth in part in the description which follows and, in part, will be obvious from the description, or may be learned by practice of the invention.

To achieve the above and/or other aspects and advantages, embodiments of the present invention set forth a packet processor which extracts a packet header field, word-aligns the extracted packet header field and stores the aligned data in an external memory, to a main processor which processes packets received through a packet communication network. The packet processor includes a serial-to-parallel converter for converting a packet in a bit stream which is received via the packet communication network into a series of words, which includes at least one byte, a queue for temporarily storing the converted word data, and a computation part for selecting, among the word data stored in the queue, a word data which corresponds to the packet header, performing bit operations with the selected word data to extract a field therefrom, and expanding the extracted field into word alignment and providing it to the main processor.

A program storage unit may be further provided. The program storage unit stores at least one program necessary for the bit operations according to a communication protocol. The computation unit selects one program for use, among the programs stored in the program storage unit in accordance with a communication protocol of the received packet.

The computation unit selectively stores the word data in different storage areas, by differentiating between a word data which corresponds to the packet header and a word data which corresponds to the packet data.

The computation part computes a checksum of the received packet, for the inspection of an error in the received packet. The computation part stores a start address to the external memory, the start address being where the result of checksum-based error inspection and the received packet are stored in the external memory, thereby transmitting the stored start address to the main processor to notify the packet reception.

To achieve the above and/or other aspects and advantages, embodiments of the present invention set forth a buffer memory controller which controls a buffer memory to extract a packet header field and align the extracted packet header field for providing the aligned extracted packet header to a main processor for packet processing, the buffer memory storing therein a word-wise parallel data including at least one byte which is converted from a packet received through a packet communication network, the buffer memory controller including a pointer storage part for storing an address of a word data containing the field, in accordance with an information regarding the field received from the main processor, at least one buffer for reading out the word data indicated by the address stored in the point storage part and buffering the read word data, and a computation part for performing bit operation with respect to the word data stored in the buffer to extract the field, expanding the extracted field to word unit and providing it to the main processor.

A barrel shifter may be further provided for shifting bits of the word data so that the field of the word data stored in the buffer can be aligned to a predetermined position. A mask generating part may be further provided for generating a mask bit to extract the field from the word data in accordance with the information regarding the field.

The computation part includes at least one logic element to perform an AND operation with respect to the word data stored in the buffer and the mask outputted from the mask generator in accordance with the information regarding the field, a NOT operation for inversing the mask, and an OR operation with respect to the word data and the inversed mask.

At least one latch may be further provided for buffering the information regarding the field which is transmitted from the main processor. The information regarding the field is transmitted to the buffer memory controller via a devoted bus installed between the main processor and the buffer memory controller.

The information regarding the field is transmitted from the main processor to the buffer memory controller via an address bus which designates an address of the buffer memory controller.

The information regarding the field is transmitted to the buffer memory controller via a data bus which transmits data from the main processor to the buffer memory controller.

To achieve the above and/or other aspects and advantages, embodiments of the present invention set forth a method of extracting a packet header field and aligning the extracted packet header field for providing the aligned extracted packet header field to a main processor. The method includes converting a packet in a bit stream which is received via the packet communication network into a word data, the word data being in word unit which includes at least one byte, selecting among the word data at least one word data which contains a field corresponding to the packet header, performing bit operations with the selected word data to extract a field therefrom, and expands the extracted field into word alignment, and providing the data contained in the field in word alignment to the main processor.

At least one among the word data selecting and the word aligning is performed in accordance with a pre-stored program in accordance with a communication protocol of the packet. At least one among the word data selecting and the word aligning is performed based on the information regarding the field being transmitted from the main processor.

Storing the word data, converted into parallel, may be further provided. The storing the data contained in the field which is word aligned, may be further provided.

To achieve the above and/or other aspects and advantages, embodiments of the present invention set forth a medium including computer readable code controlling a computational device(s) to perform embodiments of the present invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a network apparatus explaining a general packet processing;

FIG. 2 illustrates a network apparatus for explaining packet processing, according to an embodiment of the present invention;

FIG. 3 illustrates the packet processor of FIG. 2 in detail, according to an embodiment of the present invention;

FIG. 4 illustrates a network apparatus for explaining packet processing, according to another embodiment of the present invention;

FIG. 5 illustrates the buffer memory controller of FIG. 4 in detail, according to an embodiment of the present invention;

FIGS. 6A, 6B and 6C illustrate data transmission and reception between the buffer memory processor and the main processor of FIG. 4, according to embodiments of the present invention;

FIG. 7 is a flowchart illustrating a packet processor operation, according to an embodiment of the present invention; and

FIG. 8 is a flowchart illustrating a buffer memory controller operation, according to another embodiment of the present invention.

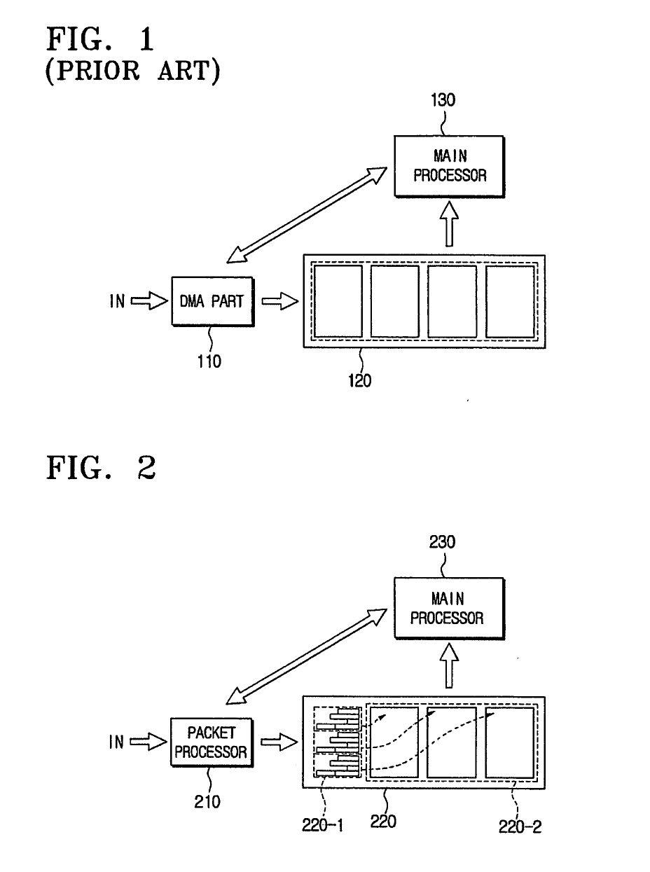

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

The matters defined in the description, such as a detailed construction and elements, are provided only to assist in a comprehensive understanding of the invention. Thus, it is apparent that the present invention can be carried out without those defined matters. Also, well-known functions or constructions are not described in detail since they would obscure the invention in unnecessary detail.

FIG. 2 illustrates a network apparatus explaining a packet processing, according to an embodiment of the present invention. Referring to FIG. 2, a packet from a network can be input to a packet processor 210.

First, the aforementioned packet processor 120 is a programmable processor and carries out the function of generic DMA units. Conversely, the packet processor 210, of FIG. 2, stores the data from the network in a memory 220. Additionally, the packet processor 210 word-wise aligns fields of the packet header, carries out inspections such as CRC and checksum for pre-processing the packets for the processing at a main processor 230.

After the pre-processing the received packets, the packet processor 210 stores the packet data and the results of packet header pre-processing, respectively, to different areas in memory 220. For the simplification of explanation, the area storing results of the packet header pre-processing will be called a processing area (220-1), and the area storing the packet data will be called a packet data area (220-2).

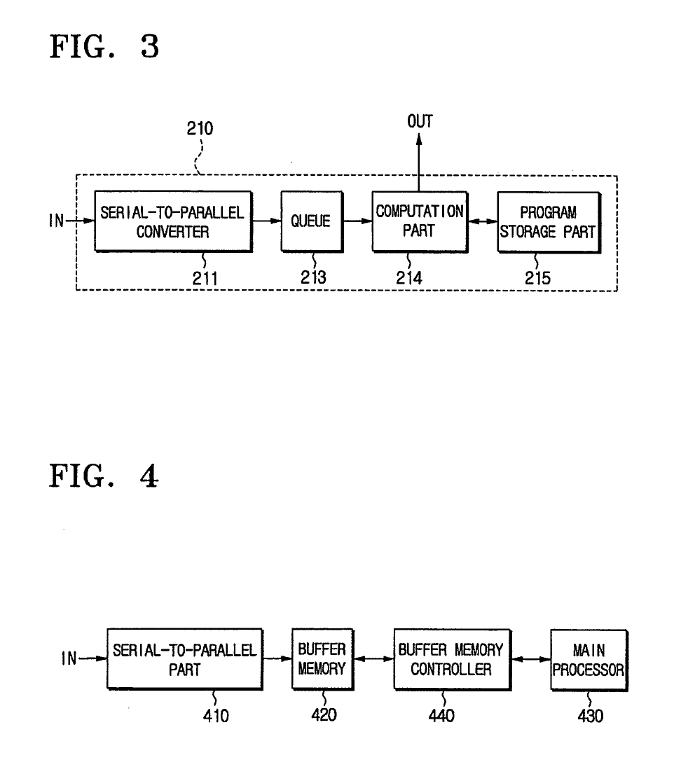

FIG. 3 illustrates the packet processor of FIG. 2, in greater detail. Referring to FIG. 3, the packet processor 210 includes a serial-to-parallel converter 211, a queue 213, a computation part 214 and a program storage part 215. Packets received from the network in a bit stream are converted into word-wise parallel data by the serial-to-parallel converter 211.

The word-wise converted parallel data are stored in the queue 213. The computation part 214 reads out data from the queue 213, inspects protocol-related data stored in the first part of the bit stream, and decides on an appropriate program for processing the received packets. The program storage part 215 stores therein programs necessary for the computation part 214 to process packet header fields, in accordance with each respective communication protocol.

The computation part 214 selects one of the programs from the program storage part 215 suitable for the packet header processing, in accordance with the predetermined protocol, and carries out packet header processing using the selected program.

The computation part 214 translates the word read from the queue 213. If the word belongs to the packet header, as typical, the computation part 214 extracts field(s) from the word by the bit-wise computations, such as shift, masking and padding, and extends the extracted field(s) in word-wise units, word aligns the extracted field(s), and stores the aligned extracted field(s) in the processing area 220-1 of the memory 220.

If one field is contained in a plurality of words, as described above, the computation part 214 extracts the field by separating and merging field-containing parts of the respective words through bit-wide computation, word-aligns the extracted field and stores it in the processing area 220-1 of the memory 220. When the data from the queue 213 belong to the packet data, the computation part 214 stores that data in the packet data area 220-2 of the memory 220.

The computation part 214 computes the checksum of the packet, and upon completing the checksum processing, inspects whether there is an error in the received packet. Next, the computation part 214 stores the result of the error inspection, as well as a start address in the memory 220 for the packets in the processing area 220-1, and notifies the main processor 230 of the packet arrival.

The bit-wise computations performed by the computation part 214, such as word-alignment and checksum calculations, do not require complicated operations, e.g., multiplication, and therefore, the computation part 214 can be easily configured so as to operate quickly.

According to an embodiment of the present invention, the packet processor 210 carries out checksum inspection of the received packet, and stores the result of the inspection in the processing area 220-1 of the memory 220. As a result, packet processing time at the main processor 230 can be reduced, and the required number of times the main processor 230 has to access the memory 220 can be reduced.

Furthermore, by subsequent reading out of the word-aligned fields stored in the processing area 220-1 of the memory 220, the packet processor 230 can carry out packet processing, such as packet header inspection, without requiring additional bit-wise computations. Because processes like word-alignment of the fields of the packet header and the packet processing can be carried out, respectively, at the packet processor 210 and the main processor 230, packet processing time can be significantly reduced.

FIG. 4 illustrates a network apparatus for explaining packet processing, in accordance with another embodiment of the present invention. Referring to FIG. 4, a packet received through the network is input in the serial-to-parallel converter 410 in a bit stream. The serial-to-parallel converter 410 converts the serial bit-wise data into byte data, or word-wise parallel data, and the converted data is input to the buffer memory 420.

The buffer memory controller 440 is installed between the buffer memory 420 and the main processor 430, and in accordance with the field information transmitted from the main memory 430, extracts fields from the buffer memory 420, word-aligns the extracted fields, and transmits the word-aligned field data to the main memory 430.

The field information from the main processor 430 to the buffer memory controller 440 includes a field length and information of the respective alignment method and extraction method. The length of the field is usually expressed in bits. According to this alignment method, as employed, it is determined whether, when the field length is shorter than the word length, to fill an upper portion of the word excluding the field with “0's” (whether to use zero-padding) or fill with a sign (whether to use sign-padding). In accordance with the field extraction method, as employed, it is determined whether, after the transmission of extracted field data to the main processor 430, to delete the transmitted field data from the buffer memory 420 (with an instruction “GET”), or to retain the field data in the buffer memory 420 (with an instruction “READ”), or to refrain from transmitting the field data to the main processor 430 and delete predetermined bits from the buffer memory 420 (with an instruction “SKIP”).

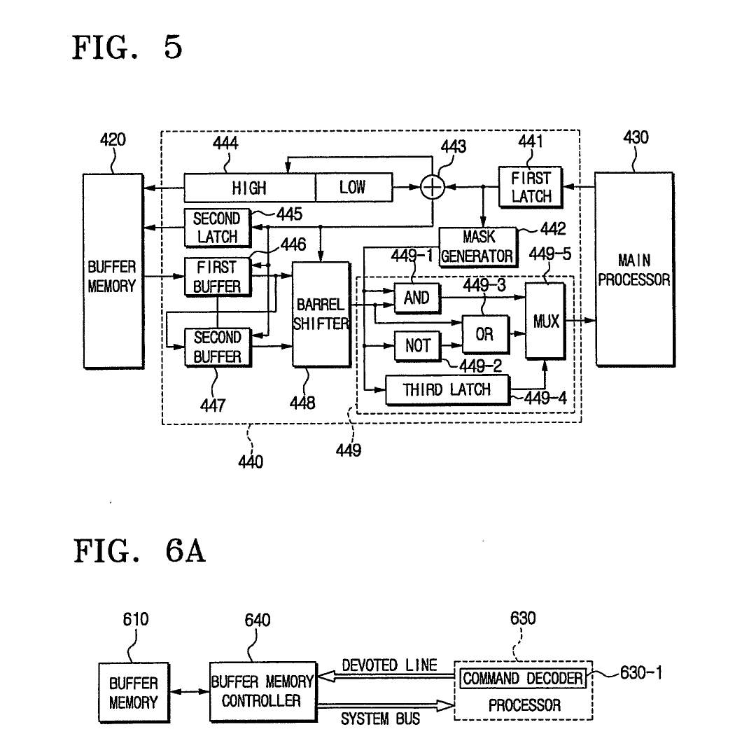

FIG. 5 illustrates the buffer memory controller of FIG. 4, in detail. Referring to FIG. 5, the buffer memory controller 440 includes a mask generator 442, a pointer storage part 444, a first buffer 446, a second buffer 447, a barrel shifter 448 and an operation part 449. The buffer memory controller 440 further includes a first latch 441, a second latch 445 and a third latch 449-1, to buffer data from the main processor 430 for a predetermined time and output the same. An adder 443 is also provided to add the output value from the first latch 441 and the output value from the pointer storage part 444.

The mask generator 442 generates mask bits, in a word length, which are made up of lower bits of “1's,” and rest “0's,” in accordance with the field length information transmitted from the main processor 430. The mask generator 442 inputs the generated mask bits to the operation part 449.

The pointer storage part 444 stores a pointer which identifies the starting bit of the word that will be read from the buffer memory 420. The MSB (Most Significant Bit) of the pointer identifies the location of the word, and the LSB (Least Significant Bit) of the pointer identifies the starting point of the field in the word. If the word is 32 bits long, the 5 LSBs of the pointer identify the location of the field in the word, and the MSBs, beginning from the sixth bit, identify the address of the word in the buffer memory 420.

The adder 443 adds the LSBs of the pointer storage part, identifying the starting point of the field in the word and output from the pointer storage part 444, with the field length being transmitted from the main processor 430. When the MSBs identifying the starting point of the word of the pointer storage part 444 are applied to the buffer memory 420, the pointer storage part 444 is updated with the sum obtained and output by the adder 443.

Meanwhile, if the MSBs output by the adder 443 change, the starting point of the word identified by the pointer storage part 444 also changes. Accordingly, the second latch 445 temporarily buffers an instruction to read from the buffer memory the word pointed by the pointer storage part 444, and applies the buffered instruction to the buffer memory 420 in accordance with a clock.

If the MSBs added by the adder 443 change, in order to detect the word and an instruction to read the word, the adder 443 transmits a signal to the second latch 445, upon the detecting of a carry in the added bits. Accordingly, the word is read from the buffer memory 420 when there is a change in the MSBs of the pointer storage part 444. If there is no change in the MSBs of the pointer storage part 444, even with the adding by the adder 443, a word is not read. In other words, the word is not read when the word containing the field is identical to the corresponding word that has already been extracted from the buffer memory 420 and stored in the first buffer 446. By using the word stored in the first buffer, a new computation of field extraction can be performed.

When the read instruction is applied from the second latch 445 to the buffer memory 420, the word stored under the address identified by the pointer storage part 444 is read, and stored in the first buffer 446. If there is no change in the MSBs of the pointer storage part 444, by the adding of the adder 443, i.e., when the field is completely contained in one word, the word stored in the first buffer 446 is transmitted to the barrel shifter 448 and the computation for field extraction starts.

If there is a change in the MSBs of the pointer storage part 444, by the adding of the adder 443, an instruction is applied from the second latch 445, requesting to read the word at the changed location. Accordingly, the previous word stored in the first buffer 446 is transmitted to the second buffer 447, and the newly read word is stored in the first buffer 446. If the field for extraction is contained in words of the first buffer 446 and the second buffer 447, the field-containing parts of the word of the first buffer and the word of the second buffer 447 are extracted and merged.

In accordance with the LSBs of the pointer storage part 444, which identifies the location of the field in the read-out word, the barrel shifter 448 performs a bit shift operation such that the location of the field can start from the lowest bit of the word.

After shifting, the word is input to the operation part 449. The operation part 449 carries out bit-wise computation with the word input from the barrel shifter 484. To this end, the operation part 449 includes logic elements of AND part 449-1, a NOT part 449-2, and an OR part 449-3, and a multiplexer 449-5 and the third latch 449-1.

The third latch 449-1 buffers the information input from the main processor regarding the field alignment method. This information accordingly indicates whether to use zero-padding or sign-padding.

The AND part 449-1 extracts the field and word-aligns the extracted field by the AND operation, with respect to the words which are shifted by the barrel shifter 448 and the masks which are input from the mask generator 442, with the masks having LSBs of “1” corresponding to the length of the field and the rest of the bits being “0.”

The NOT part 449-2 inverses the mask generated by the mask generator 442, and the OR part 449-3 extracts the fields and word-aligns the extracted fields by the OR operation, with respect to the inversed masks from the NOT part 49-2 and the shifted words from the barrel shifter 448. The multiplexer 449-5 selectively outputs an output of the AND part 449-1 and the OR part 449-3, in accordance with the output information from the third latch 449-1, and the extracted fields are transmitted to the main processor 430.

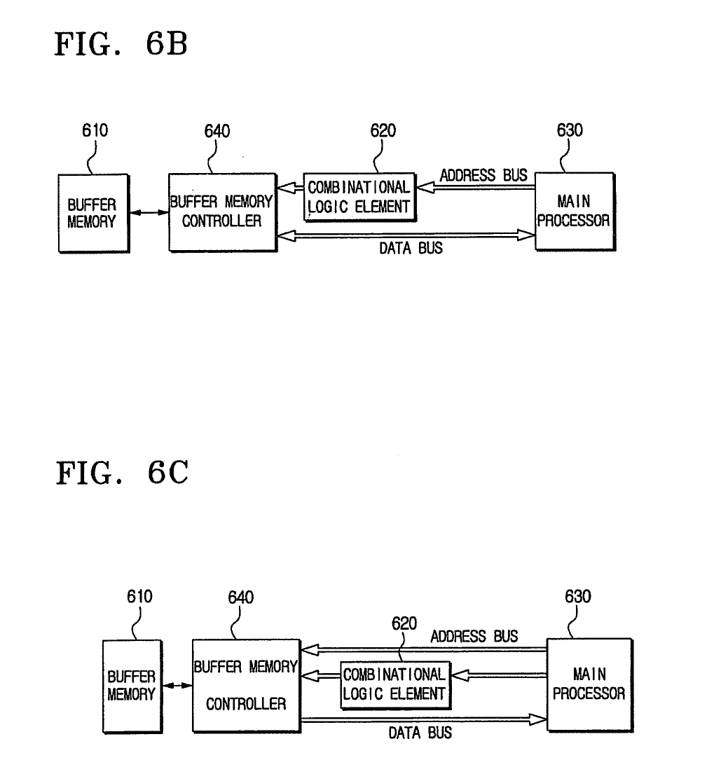

FIGS. 6A, 6B and 6C show first through third example communication methods for the buffer memory controller and the main processor of FIG. 4, respectively.

Referring to FIG. 6A, the main processor, using the first example communication method, generates a control signal with respect to instructions from the instruction decoder 630-1, such as “GET”, “READ” and “SKIP”, and a control signal with respect to the field length and field alignment so as to restrain the change of the existing pipeline as much as possible. The main processor is also provided with a special-purpose line such, as pins, so that it can transmit to the buffer memory controller 640 the control signals and the signal indicating register information of the main processor 630, the recipient of the extracted field data, without using a system bus.

The field data, which is extracted and word-aligned in the buffer memory controller 640, is transmitted to the main processor 630 via the system bus. This method requires numerous changes of hardware, but provides advantages that communication between the main processor 630 and the buffer memory controller 640 is efficiently carried out with one single instruction.

Referring to FIG. 6B, according to the second example communication method, a general system bus may be employed for the communication between the buffer memory controller 640 and the main processor 630. The main processor 630 accesses the address that is pre-designated in the address bus, to designate the buffer memory controller 640. Accordingly, the main processor 630 transmits information to the buffer memory controller 640 via the address bus. A combinational logic element 620, provided between the buffer memory controller 640 and the main processor 630, converts the address of the address bus into control data if the address is used in the buffer memory controller 640. For example, the combinational logic element 620 converts the address “0xffff0010” into suitable information for the buffer memory controller 640 such as field length “1” or field information such as “zero-padding,” and transmits the converted data to the buffer memory controller 640.

Upon completion of the operation at the buffer memory controller 640 with respect to the fields, in accordance with the instruction “LOAD” of the main processor 630, the field data is transmitted to the main processor 630 via the data bus. The second method requires at least two instructions, but instead provides an advantage in that the buffer memory controller 640 can be used through a modification in addressing of the buffer memory.

Referring to FIG. 6C, according to the third example communication method, a register (not shown) is additionally provided to the buffer memory controller 640 and allocated with an address. When the register (not shown) is addressed via the address bus, the control data from the main processor 630 to the buffer memory controller 640 is transmitted via the data bus and stored in the register (not shown). The combinational logic element 620 requires decoding of the information if the data bus has narrow width and the control information from the main processor 630 has to be encoded. Otherwise, decoding is not necessary.

In accordance with the control data stored in the register (not shown), the buffer memory controller 640, upon completion of the operation at the buffer memory controller 640, with respect to the fields, transmits the field data to the main processor 430 via the data bus, in accordance with the “LOAD” instruction from the main processor. The third communication method is somewhat similar to the second communication method, but provides an advantage that the space requirement for address storage of the main processor 630 can be reduced.

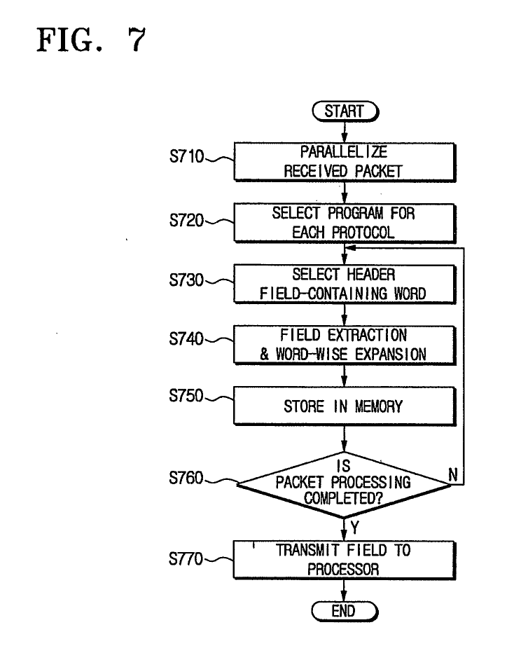

FIG. 7 is a flowchart illustrating the operation of a packet processor, according to an embodiment of the present invention.

Packets in a serial bit stream received through the network are converted into word-wise parallel data and buffered (operation S710). Among the buffered data, protocol-related data stored in a first part of the bit stream is inspected for an indication of which program should be used for the packet processing (operation S720).

Next, data corresponding to a packet header is selected among the word-wise parallel data that are buffered using the program selected for the packet header field processing, in accordance with the packet protocol (operation S730), and fields are extracted from the selected data and expanded to word alignment by bit operations, such as shift, masking and padding operation (operation S740).

If one field is embodied in a plurality of words, each part of the words containing the field is separated from the separate words and combined with one another into a word alignment.

After field extraction and word-alignment, the field data are stored in the processing range of the memory (operation S750). If the input word corresponds to the packet data, the word is stored in the packet data range of the memory.

When a checksum of the packets is calculated and the packet processing is completed, the final value of the checksum and the received checksum are compared with each other, and it is determined whether there is a difference between the checksums for error checking.

The result of inspection and the starting address of the corresponding packet in the memory are stored in the processing range, and the main processor is notified of the packet arrival. Accordingly, the main processor transmits to the memory a signal for the reading of necessary field(s) for packet header processing, extracts field data from the memory and attends to header processing.

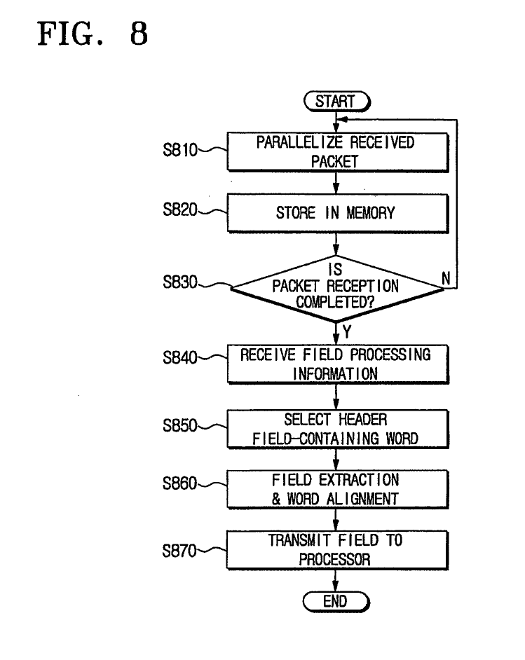

FIG. 8 is a flowchart illustrating the operation of a buffer memory controller, according to another embodiment of the present invention. Referring to FIG. 8, packets in serial bit stream from the network are converted into word-wise parallel data (operation S810), and stored in the memory (operation S820).

When the packet reception and storage are completed (operation S830), bit operations are carried out with respect to the respective fields of the received packet headers, and field information is received from the main processor for the word alignment (operation S840).

The word data containing a field of the packet header is selected among the stored word-wise parallel data, in accordance with the field information (operation S850), the selected word data is read from the memory, and the field is extracted from the read word. Then, by bit operations such as shift, masking, and padding operations, the extracted fields are expanded to word alignment (operation S860), and transmitted to the main processor (operation S870).

In addition to the above described embodiments, embodiments of the present invention can be implemented through computer readable code and implemented in general-use digital computers through use of a computer readable medium including the computer readable code. The computer readable medium can correspond to any medium/media permitting the storing or transmission of the computer readable code.

The structure of data used in the embodiments of the present invention described above can be recorded on a computer readable recording medium in a variety of ways. Examples of the computer readable medium may include magnetic storage media (e.g., ROM, floppy disks, hard disks, etc.), optical recording media (e.g., CD-ROMs, or DVDs), and storage media such as carrier waves (e.g., transmission through the Internet).

As described above in a few exemplary embodiments of the present invention, the buffer memory controller and method thereof enables extraction and word-alignment of the respective fields of the received packet header by performing the bit operations separately from the main processor. Accordingly, requirements for the main processor to perform bit operations for the packet header processing can be reduced, and therefore, packet processing efficiency can be improved.

Furthermore, because operations for packet header field processing can be performed in parallel, i.e., separately from the packet processing at the main processor, packet processing speed increases, and fast packet processing can be provided, thereby satisfying fast network requirements.

Although a few embodiments of the present invention have been shown and described, it would be appreciated by those skilled in the art that changes may be made in these embodiments without departing from the principles and spirit of the invention, the scope of which is defined in the claims and their equivalents.

1. A packet processor extracting a packet header field, word-aligning the extracted packet header field, and storing the aligned data in an external memory, for a main processor which processes packets received through a packet communication network, the packet processor comprising:
a serial-to-parallel converter converting a packet in a bit stream, received via the packet communication network, into a word data, the word data comprising a word unit which comprises at least one byte;
a queue temporarily storing the converted word data; and
a computation part selecting, among the word data stored in the queue, a word data which corresponds to a packet header, performing bit operations with the selected word data to extract a field therefrom, and expanding the extracted field into word alignment and providing it to the main processor.

2. The packet processor of claim 1, further comprising a program storage part which stores at least one program necessary for the bit operations of the computation part according to a communication protocol,
wherein the computation part selects one program for use, among the programs stored in the program storage part, in accordance with a communication protocol of the received packet.

3. The packet processor of claim 1, wherein the computation part selectively stores the word data in different storage areas, by differentiating between a word data which corresponds to the packet header and a word data which corresponds to the packet data.

4. The packet processor of claim 1, wherein the computation part computes a checksum of the received packet, compares the checksum with another checksum contained in the transmitted packet, for the inspection of an error in the received packet.

5. The packet processor of claim 4, wherein the computation part stores a start address of the external memory, the start address being where the result of checksum-based error inspection and the received packet are stored at the external memory, thereby transmitting the stored start address to the main processor to notify of the packet reception.

6. A buffer memory controller to control a buffer memory to extract a packet header field and align the extracted packet header field for providing to a main processor for packet processing, the buffer memory storing therein a word-wise parallel data comprising at least one byte, which is converted from a packet received through a packet communication network, the buffer memory controller comprising:
a pointer storage part storing an address of a word data containing a field, in accordance with an information regarding the field received from the main processor;
at least one buffer reading out the word data identified by the address stored in the point storage part and buffering the read word data; and
a computation part performing bit operations with respect to the word data stored in the buffer to extract the field, expanding the extracted field to a word unit, and providing the word unit to the main processor.

7. The buffer memory controller of claim 6, further comprising a barrel shifter for shifting bits of the word data so that the field of the word data stored in the buffer can be aligned to a predetermined position.

8. The buffer memory controller of claim 6, further comprising a mask generating part for generating a mask bit to extract the field from the word data in accordance with the information regarding the field.

9. The buffer memory controller of claim 8, wherein the computation part comprises at least one logic element to perform an AND operation with respect to the word data stored in the buffer and the mask output from the mask generator in accordance with the information regarding the field, a NOT operation for inversing the mask, and an OR operation with respect to the word data and the inversed mask.

10. The buffer memory controller of claim 6, further comprising at least one latch for buffering the information regarding the field which is transmitted from the main processor.

11. The buffer memory controller of claim 10, wherein the latch buffers information, input from the main processor regarding a corresponding field alignment method, with the buffered information indicating whether to use zero-padding or sign-padding.

12. The buffer memory controller of claim 6, wherein the information regarding the field received from the main processor further comprises a corresponding field length information, field alignment method, and/or extraction method.

13. The buffer memory controller of claim 12, wherein when the field length is shorter than a word length an upper portion of the word unit is filled excluding fields with “0's” or signs.

14. The buffer memory controller of claim 12, wherein, after transmission of extracted field data to the main processor, the transmitted field data is deleted from the buffer memory with an instruction “GET,” retained with an instruction “READ,” or refrained from being transmitted to the main processor and delete predetermined bits from the buffer memory with an instruction “SKIP.”

15. The buffer memory controller of claim 6, wherein the information regarding the field is transmitted to the buffer memory controller via a devoted line installed between the main processor and the buffer memory controller.

16. The buffer memory controller of claim 6, wherein the information regarding the field is transmitted from the main processor to the buffer memory controller via an address bus which designates an address of the buffer memory controller.

17. The buffer memory controller of claim 6, wherein the information regarding the field is transmitted to the buffer memory controller via a data bus which transmits data from the main processor to the buffer memory controller.

18. A method of extracting a packet header field and aligning the extracted packet header field for providing to a main processor, the method comprising:
converting a packet in a bit stream received via a packet communication network into a word data, the word data being in a word unit, which comprises at least one byte;
selecting among the word data at least one word data which contains a field corresponding to the packet header;
performing bit operations with the selected word data to extract a field therefrom, and expanding the extracted field through word alignment; and
providing the data contained in the field, in word alignment, to the main processor.

19. The method of claim 18, wherein at least one among the word data selecting and the word aligning is performed in accordance with a pre-stored program in accordance with a communication protocol for the packet.

20. The method of claim 18, wherein at least one among the word data selecting and the word aligning is performed based on the information regarding the field being transmitted from the main processor.

21. The method of claim 18, further comprising storing the word data which is converted into parallel data.

22. The method of claim 18, further comprising storing the data contained in the field in word alignment.

23. A medium comprising computer readable code controlling a computational device(s) to perform the method of claim 18.
